(19) United States
(12) Patent Application Publication
(10) Pub. No.: US 2009/0263666 A1
(43) Pub. Date: Oct. 22, 2009

(54) Process of Powder Coating and a Powder Coating Apparatus

(76) Inventor: Ian Webb, Kent (GB)

Correspondence Address: Fay Sharpe LLP, 1228 Euclid Avenue, 5th Floor, The Halle Building, Cleveland, OH, 44115, US

(21) Appl. No.: 11/988,838

(22) PCT Filed: Jul. 13, 2006
(86) PCT No.: PCT/GB2006/050202

§ 371 Date: Jan. 15, 2008

(30) Foreign Application Priority Data
Jul. 19, 2005 (GB) 0514778.0

(51) Int. Cl. B05D 3/02; B05C 3/00; B32B 17/06; B32B 21/04

(52) U.S. Cl. 428/426; 427/508; 118/641; 428/537.1

(57) ABSTRACT

A process of dry powder coating a thermo-curing resin onto a heat sensitive or a thermally insensitive substrate includes depositing a layer of dry uncured thermo-curing powder on the substrate. The coated substrate is passed through a curing station wherein the layer of thermosetting dry powder is irradiated with infrared radiation until the layer of thermosetting dry powder is cured. The infrared radiation is generated from ceramic glass elements. Also disclosed is a powder coated article, including a heat sensitive substrate coated directly with a coating of a thermosetting thermo-curing powder.

The present invention is concerned with powder coating. The process of the invention was particularly developed with the object of powder coating temperature sensitive substrates consisting of fibrous organic material. For the present purpose fibrous material consists of materials such as wood, fibreboard, chipboard and the like which are commonly used for furniture components, joinery products such as doors, mouldings and windows and building boards such as flooring, panelling, internal wall linings and ceilings. However, development of the process has determined that it is unexpectedly advantageous when applied to the process of powder coating even non-temperature sensitive materials, for example components formed primarily of iron, steel and aluminium.

The process of powder coating consists in known manner of depositing a thermo-curing plastics resin in the form of fine granules onto a substrate and then curing the resin so that it consolidates into a hard, tough, smooth surface layer coating the substrate. The process of curing consists principally in heating the resin to a critical temperature for a critical period so that it sinters and bonds to the substrate.

Conventionally the powder coating process applied to heat insensitive materials consists of the steps of: preparing the surface of the substrate by steps such as cleaning and abrading to provide a surface key, depositing powder coat onto the surface via a process such as electrostatic spraying and then curing the powder coat by heating in a convection oven for a curing period. Thermo curing powders are either thermosetting or thermo plastic. It is very desirable that the powder coat process have a minimum number of process steps to finish it. It is further very preferable to avoid the use of solvent based coatings to prime the material surface because of the environmental and other process problems these produce.

The process has been in use for many years to surface finish temperature insensitive materials such as metals. However, the temperatures at which curing of even low temperature curing powder compositions take place are in excess of 80 C and such low curing temperatures lead to counter productively prolonged curing times and consequently low productivity. It is important that the part of the coating in contact with the substrate is well cured or it will not bond effectively to the substrate and the strength and toughness of the coating will be adversely affected. This in turn means that the surface of the substrate at least must be exposed to the curing temperatures.

Fibrous substrates (which term is herein to be taken to mean natural wood, fibreboard and chipboard at least) contain quantities of materials, especially water, which are volatile at the curing temperature. Accordingly these materials are inclined to vaporise during powder coat curing. The consequence is that the powder coat fails to bond uniformly to the substrate and gassing out results in unacceptable, unsightly deformation of the cured powder coating.

In addition to the unacceptable coating quality, heat sensitive fibrous substrates such as wood are inclined to crack and warp out of shape when heated, especially when heated for prolonged periods.

A further problem arises with certain type of pigmented powder coating where the pigment is opaque to radiation and will act as a barrier. In this case the surface of the coating is cured first but prevents heating and curing of the layer of coating closest to the substrate.

Prior art attempts to solve the problems associated with curing dry powder coatings onto heat sensitive substrates are disclosed in U.S. Pat. No. 6,296,939. In particular U.S. Pat. No. 6,296,939 discloses a process in which a layered material consisting of a substrate of heat-sensitive material, preferably wood has a powder paint coat applied thereon. The coat is produced by a) application of an extender coat, b) application of at least one (water-based) paint, c) heating of the substrate by microwave radiation, d) hardening of the liquid paint, preferably by ultraviolet radiation, e) application of the powder paint, preferably by electrostatic spraying or by the Tribo process, f) heating of the powder paint to sintering temperature, g) subsequent hardening of the paint coat.

EP1424142 discloses a method of powder coating a heat sensitive substrate by conveying it through powder coating apparatus, and including the steps of: pre-heating the substrate in a preheating zone to an elevated temperature in an oven zone, the preheating being sufficient to help the powder reach its flow temperature and/or to minimise out gassing during cure; applying coating powder to the preheated substrate in the coating zone to coat the substrate; heating the coated substrate in a curing zone to a curing temperature of 82 C or higher and, cooling the coated substrate to a temperature suitable for stacking. The two component powder coating method involves preheating the substrate in an oven to cause the powder to reach its flow temperature and minimizes out gassing. Coating powder is applied to the preheated substrate to coat the substrate and cured in a curing zone to a temperature of eighty two degrees Centigrade or higher. The coated substrate is then cooled.

WO9622843 discloses a process for powder-coating or stove-enamelling (with thermo curable materials) work pieces of temperature-sensitive materials, especially timber, fibreboard and plastics, in which the work piece is first given a temperature-insulating protective coating resistant to temperatures of up to at least 300 DEG C. with a heat conductivity such that, when heated on the side away from the work piece from 80 to 300 DEG C. for between 5 and 45 minutes, the maximum temperature on the side towards the work piece is 70 C, thereafter the previously protectively coated work piece is powder-coated or given a coat of stove-enamel (thermo curable materials) and the coated work piece is then taken to a cross-linking temperature of between 80 and 300 C for 5 to 45 minutes.

Each of these prior art processes present problems in that coatings additional to the powder coat are required. These coatings usually include volatiles which cause inconvenience. Further heating and or irradiation curing steps are required to pre-treat the substrate and cure the volatile paint layer prior to curing the powder coat layer. Each of these steps make the process uneconomic for most applications. In some cases the process requires prolonged curing times which are inconvenient in that they slow the production process down and are likely to exacerbate the previously mentioned cracking and deformation of the substrate. In the case of using ultraviolet curing the pigments used to colour the powder coat are commonly opaque to the UV radiation so that the powder coat adjacent the substrate does not cure without prolonged exposure.

The ultraviolet curing step such as that disclosed in U.S. Pat. No. 6,296,939 is only effective in curing of planar surfaces. This limits the application of the process to exclude substrates exhibiting profiles and mouldings common to many designs of doors and furniture.

It is an object of the present invention to alleviate at least some of the aforementioned technical problems exhibited by the prior art.

Accordingly there is provided a process of powder coating a substrate comprising the steps of: depositing a layer of dry uncured thermo curing powder on a substrate, passing the coated substrate through a curing station wherein the layer of thermosetting dry powder is irradiated with infrared radiation until the layer of thermosetting dry powder is cured characterised by the step of generating said infrared radiation from ceramic glass elements.

Unexpectedly the step of using a ceramic glass element to cure the powder coat substantially reduces the curing time for all powder coats tested. By way of example it was found that curing times of as little as 75 seconds' were sufficient in some applications where curing times of approximately 600 seconds would be required with conventional processes.

The substrate may be a thermally sensitive material such as a natural or engineered wood, e.g., plywood, fibreboard board, chipboard, or oriented strand board. Other potential substrates with heat sensitive characteristics include boards such as fibre reinforced gypsum panel or fibre reinforced paper boards. The substrate may also be a thermally sensitive synthetic material, e.g., a plastics material particularly recycled plastics or a foil laminated product. Materials not ordinarily regarded as thermally sensitive such as glass may provide the substrate. In practice the prolonged exposure of glass can cause severe thermal strain. Certain speciality glasses such as those used in fibre optics, may have their performance characteristics severely impaired by prolonged exposure to high temperatures. Alternatively the substrate may be a thermally insensitive material such as components of iron, steel or aluminium section, concrete or stone.

The curing station will ordinarily consist of an oven having an enclosure supporting an internal array of ceramic glass infrared elements. The infrared radiation from these elements is of very uniform distribution so that the powder coating of the substrate is very uniformly heated. Curing can thus take place relatively rapidly, and under accurately calibrated control so that little heating of the substrate is effected during the curing process and no out gassing occurs to damage the coating.

According to a second aspect the present invention comprises the use of a curing oven having ceramic glass elements to emit infrared radiation in a process to powder coat a heat sensitive substrate.

According to a third aspect of the present invention there is provided an oven for curing thermosetting powder on a heat sensitive substrate wherein the oven includes infrared radiation emitters comprising ceramic glass elements.

Ceramic glass elements in the present case may be formed of fused quartz emitters heated by gas jet burners. The oven may conveniently consist of arrays of such ceramic glass elements disposed to produce a uniform flux of radiation with which the surface of an article being coated in the process is irradiated.

According to a fourth aspect of the present invention there is provided a powder coated article comprising a heat sensitive substrate coated directly with a coating of thermosetting powder coating cured by infrared radiation from ceramic glass elements.

In some applications of the invention the powder coat applied directly to the substrate may be used as a substrate for second layer of powder coat. The second layer may be used to enhance the colour, finish or durability of the first coating.

The substrate may be any fibrous organic material, for example fibreboard, chipboard or natural wood. The substrate may include non planar surfaces, such as decorative mouldings. The powder coat is bonded directly onto the surface of the substrate without the intervention of any priming or thermal protection layer.

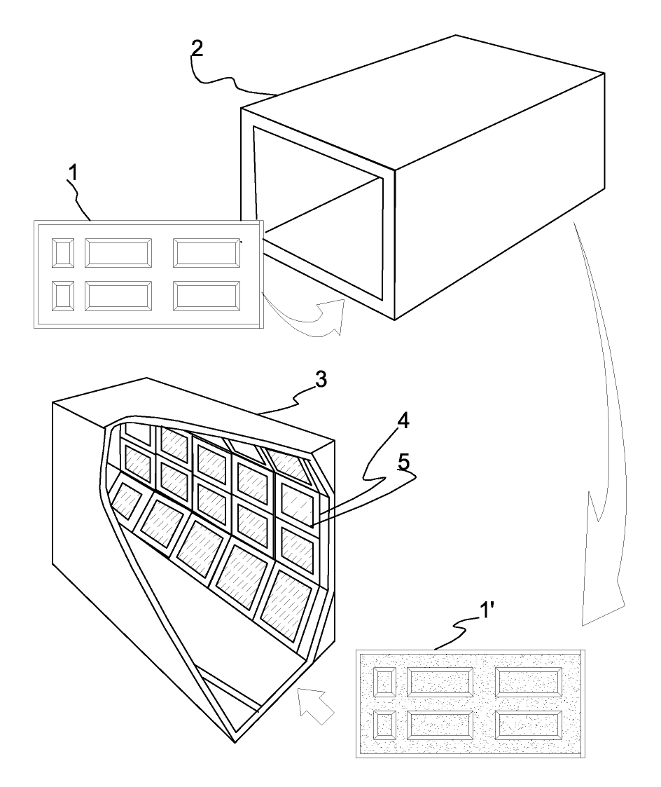

The process of the invention will now be described by way of example only with reference to the accompanying FIG. 1.

FIG. 1 illustrates diagrammatically the process of powder coating a door 1 fabricated from chipboard. Chipboard is seen as a particularly good base for finishing by powder coating because of its low cost, high strength, good thermal and acoustic insulation properties. Chipboard would make an excellent construction material if it were possible to effectively weatherproof it and provide it with an attractive finish. At stage 1 shown in the top left hand of the diagram the door is surface treated by abrasion and cleaning (e.g. via compressed air) to remove loose material and fouling

The door may be preheated to improve the adhesion of powder during the subsequent step. The desirability of a preheat step will depend largely on the nature of the material to be coated and other characteristics of a subsequent powder deposition step.

After cleaning and, possibly preheating, the door is fed to a spraying apparatus 2. In some applications the spraying apparatus may be of electrostatic type or preferably tribostatic type which encourages a uniform pre-curing coat and adhesion thereof to the article. Preheating the article encourages the powder to adhere prior to curing, which is especially useful where solely electrostatic spraying is not possible. The spraying apparatus, which may be manually or robotically operated, deposits a layer of thermosetting powder coat onto the surface of the unfinished door 1.

The powder coated door 1′ is then conveyed to a curing station provided by an infrared radiant curing oven. This consists of a housing 3 which insulates and protects the interior curing chamber. Surrounding the curing chamber are deployed arrays of infra red radiant heating elements 4. Each radiant heater 4 includes a glass ceramic (fused quartz) radiant element 5 which is heated by an associated gas burner (not shown) so that it radiates infrared radiation in a very evenly distributed manner. Preferably the powder coating material will have a curing temperature, for example below 220 C and possibly 160 C or 120 C. The radiant elements of the curing oven operate at a temperature of around 850 C. Thus as the door is passed through the curing oven chamber the powder coat is exposed to radiant heat in a highly controlled manner which produces rapid and uniform curing of the powder coat without significantly heating the underlying chipboard substrate of the door. In consequence there is no out gassing from the door to damage the powder coat and the substrate is unlikely to crack or deform.

In one test favourable results were achieved by preheating the substrate for two minutes (120 seconds) and subsequently curing for one and one quarter minutes (75 seconds). Such results are for the sake of example and the invention certainly contemplates the possibility of a range of preheat and curing times according to the product for example:

preheat times between 30 seconds and 300 seconds are contemplated and preferably times between 90 seconds and 150 seconds

curing times may range between 30 seconds and 240 seconds. Preferred curing times would be between 60 seconds and 90 seconds.

It will be appreciated that the example of a door is not limiting and many other articles may be profitably powder coated by the process. Some examples include internal furniture, particularly; bathroom furniture, kitchen furniture; internal building boards such as wood flooring, internal wall lining products, ceiling panels. External applications include joinery products such as; window frames and external doors, external building boards in the form of; roofing products such as soffits, barge board, facias, shingles and curtain walling or exterior facade cladding, either stock board or custom panelling. Because the powder coat is a substantially conventional thermo-curing powder coat of either thermosetting or thermoplastic type as desired, the coating may be coloured or transparent as preferred.

Competing processes to coat MDF use moisture depleted MDF to avoid out-gassing problems. Because of the moisture depletion the conductivity of the MDF is reduced and consequently preheat becomes essential as powder will not adhere in a purely electrostatic/tribostatic spraying process. The moisture depleted MDF is a less economic product than standard MDF products. The present invention may be used on conventional MDF and may be applied without preheating the board.

1. A process of powder coating a substrate comprising the steps of: depositing a layer of dry uncured thermo curing powder on a substrate, passing the coated substrate through a curing station wherein the layer of thermosetting dry powder is irradiated with infrared radiation until the layer of thermosetting dry powder is cured characterised by the step of generating said infrared radiation from ceramic glass elements.

2. A process according to claim 1 wherein only the dry powder coat is deposited prior to curing.

3. A process according to claim 1 wherein the surface of the substrate is prepared only by abrading to provide a key and cleaning.

4. A process of powder coating according to claim 1 wherein the substrate is heat sensitive.

5-6. (canceled)

7. A process according to claim 2 wherein the substrate is formed from a wood material.

8. A process according to claim 1 wherein the substrate is thermally insensitive.

9. A process according to claim 8 wherein the substrate material is selected from one of: (i) a metal (ii) glass (iii) concrete (iv) stone

10. Use of a curing oven having ceramic glass elements to emit infrared radiation in a process to cure a powder coat on a substrate in a process according to claim 1.

11. Use of a curing oven according to claim 10 in a process wherein the substrate is heat sensitive.

12. Use of a curing oven according to claim 10 wherein the substrate is heat insensitive.

13. A powder coating oven adapted for use in a process according to claim 1 by the inclusion of infrared radiation emitters comprising ceramic glass elements.

14. A powder coated article comprising a heat sensitive substrate coated directly with a coating of thermosetting thermo-curing powder coating cured by infrared irradiation from ceramic glass elements.

15. A powder coated article according to claim 14 wherein the substrate is coated exclusively with the coating or coatings of thermosetting powder coat.

16. A powder coated article according to claim 14 wherein the article is an article of internal joinery.

17. A powder coated article according to claim 14 wherein the article comprises internal furniture.

18. (canceled)

19. A powder coated article according to claim 14 wherein the article is comprises at least one of an internal building board; wood flooring; and an internal wall lining product.

20-22. (canceled)

23. A powder coated article according to claim 14 wherein the article is comprises at least one of an external joinery product; a window frame; and an external door.

24-25. (canceled)

26. A powder coated article according to claim 14 wherein the article comprises at least one of a roofing product; a sofit: a barge board; facia: a shingle; and an exterior facade cladding board.

27-29. (canceled)

30. A powder coated article according to claim 14 wherein the substrate is a glass.
